(19) United States
(12) Patent Application Publication
(10) Pub. No.: US 2010/0050460 A1
(43) Pub. Date: Mar. 4, 2010

(54) DRYER HAVING MIXING TYPE LIFTER

(75) Inventor: Ui Kun HWANG, Bucheon-si (KR)

Correspondence Address: SCHMEISER, OLSEN & WATTS, 22 CENTURY HILL DRIVE, SUITE 302, LATHAM, NY, 12110, US

(73) Assignee: DAEWOO ELECTRONICS CORPORATION, SEOUL (KR)

(21) Appl. No.: 12/549,421

(22) Filed: Aug. 28, 2009

(30) Foreign Application Priority Data
Aug. 28, 2008 (KR) 10-2008-0084217

(51) Int. Cl. F26B 11/02

(52) U.S. Cl. 34/108

(57) ABSTRACT

A dryer includes a mixing type lifter to increase a contact area between laundry and air blown to the laundry. The lifter includes a main body provided to a drum of the dryer to move laundry received in the drum, a bent section formed on the main body to cause three-dimensional movement of the laundry, and a separation maintaining section formed on the main body to form a space between the laundry and the main body.

### BACKGROUND OF THE INVENTION

1. Field of the Invention

The present invention relates to dryers and, more particularly, to a dryer having a mixing type lifter that increases a contact area between laundry and air blown to the laundry.

2. Description of the Related Art

FIG. 1 is a schematic sectional view showing a flow passage of a conventional dryer, and FIG. 2 is a partially cut-away perspective view of the conventional dryer.

Referring to FIGS. 1 and 2, the conventional dryer includes a cabinet 2 constituting an outer appearance of the dryer and having an opening through which laundry is input or removed; a drum 12 rotatably disposed inside the cabinet 2 to receive the laundry and opened at front and rear sides to allow air to pass therethrough; a heater 18 disposed inside the cabinet 2 to heat air introduced into the cabinet 2; an intake duct 20 guiding air heated by the heater 18 to the rear of the drum 12; an exhaust mechanism 22 for discharging air, which is used to dry the laundry, to an outside of the cabinet 2; a ventilation fan (not shown) provided to the exhaust mechanism 22; a motor 40 driving the drum 12 and the ventilation fan (not shown) and connected to a belt 50.

The drum 12 is provided on an inner peripheral surface thereof with lifters 11.

The exhaust mechanism 22 includes a lint duct 25 defining a flow passage of air discharged from the drum 12 and having a filter 24 to separate foreign matter from air passing through the lint duct 25, a fan housing 26 communicating with the lint duct 25 and surrounding the ventilation fan, and an exhaust duct 27 communicating at one end thereof with the fan housing 26 and having the other end disposed outside the cabinet 2.

Operation of the conventional dryer will hereinafter be described.

First, when the dryer is operated with an item to be dried, for example, laundry, received in the drum 12, the motor is driven to rotate the drum 12 and the ventilation fan, and the heater 18 is operated.

While the drum 12 is rotated, the laundry received in the drum 12 is lifted by the lifters 11 and then falls down inside the drum 12.

Further, while being suctioned through the heater 18 by a ventilation force caused by rotation of the ventilation fan, external air is changed into high-temperature, low-humidity air by the heater 18 and flows into the drum 12 through the intake duct 20.

Inside the drum 12, high-temperature, low-humidity air passed into the drum 12 directly contacts and dries the laundry being tumbled in the drum 12. Then, the air changes into low-temperature, high-humidity air while moving towards the front side of the drum 12, and is finally discharged to the outside of the dryer through the exhaust duct 27.

Here, it should be noted that the aforementioned technique is described for understanding the related art of the invention and is not a well-known conventional technique in the art.

In the conventional dryer, however, the linear shape of the lifters permits only two-dimensional movement of lifting and dropping the laundry inside the drum and causes the laundry to closely contact the lifters thus making it difficult for warm air to pass between the lifters and the laundry so that the contact area between the air and the laundry cannot exceed a predetermined area inside the drum.

Therefore, there is a need to provide an improved dryer that overcomes such problems.

### SUMMARY OF THE INVENTION

The present invention is conceived to solve the problems of the related art, and an aspect of the invention is to provide a dryer having a mixing type lifter that increases a contact area between warm air and laundry.

In accordance with an aspect of the invention, a dryer having a mixing type lifter is provided, wherein the lifter includes a main body provided to a drum of the dryer to move laundry in the drum; a bent section formed on the main body to make three-dimensional movement of the laundry; and a separation maintaining section formed on the main body to form a space between the laundry and the main body.

The main body may include a curved section on one side thereof corresponding to the drum.

The bent section may include a first bent section formed at one end of the main body and a second bent section formed at the other end thereof and bent in an opposite direction to the first bent section.

The separation maintaining section may include a protrusion formed on the main body.

The separation maintaining section may include a groove formed on the main body.

### BRIEF DESCRIPTION OF THE DRAWINGS

The above and other aspects, features, and advantages of the invention will become apparent from the following detailed description of embodiments of the invention in conjunction with the accompanying drawings, in which:

FIG. 1 is a schematic sectional view showing a flow passage of a conventional dryer;

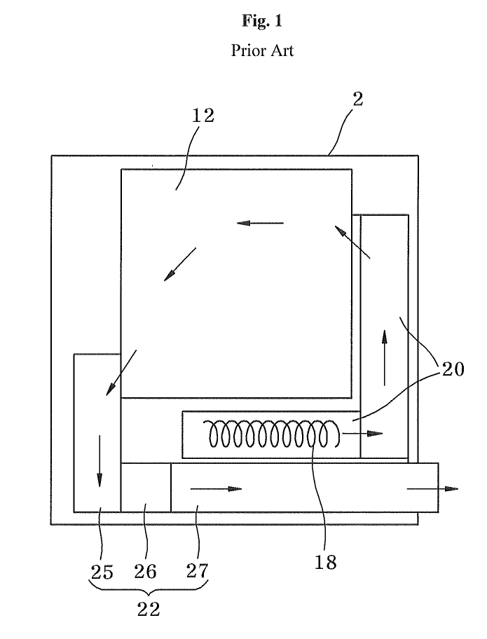

FIG. 2 is a partially cut-away perspective view of the conventional dryer;

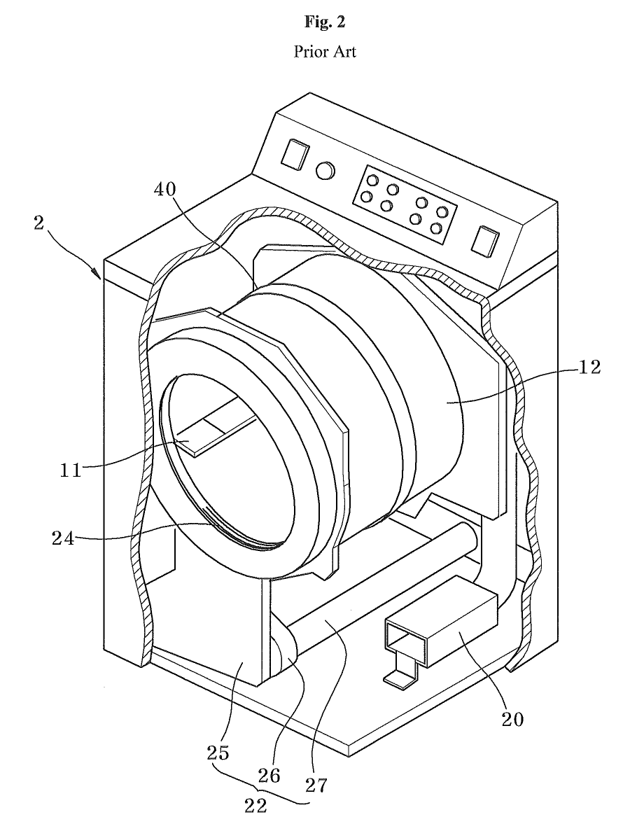

FIG. 3 is a rear perspective view of a dryer in accordance with one embodiment of the present invention;

FIG. 4 is a front perspective view of the dryer in accordance with the embodiment of the present invention;

FIG. 5 is a rear perspective view of the dryer in accordance with the embodiment of the present invention, showing an intake port and an air vent of the dryer;

FIG. 6 is a plan view of a mixing type lifter in accordance with one embodiment of the present invention;

FIG. 7 is a side view of the mixing type lifter in accordance with the embodiment of the present invention;

FIG. 8 is a plan view of an intake flow passage of the dryer in accordance with the embodiment of the present invention;

FIG. 9 is a side-sectional view of the intake flow passage of the dryer in accordance with the embodiment of the present invention;

FIG. 10 is a plan view of a discharge flow passage of the dryer in accordance with the embodiment of the present invention; and

FIG. 11 is a plan view of a mixing type lifter in accordance with another embodiment of the present invention.

### DETAILED DESCRIPTION OF THE EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity.

Furthermore, the terms as used herein are defined by taking functions of the present invention into account and can be changed according to the custom or intention of users or operators. Therefore, definition of the terms should be made according to the entirety of the disclosure set forth herein.

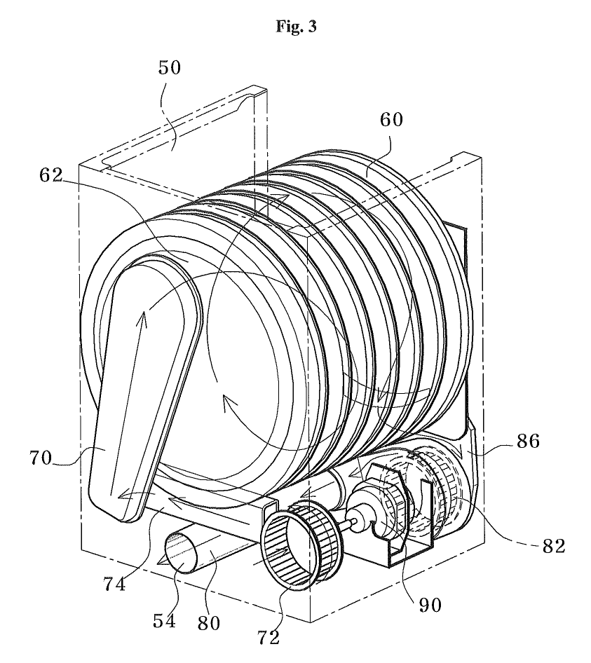

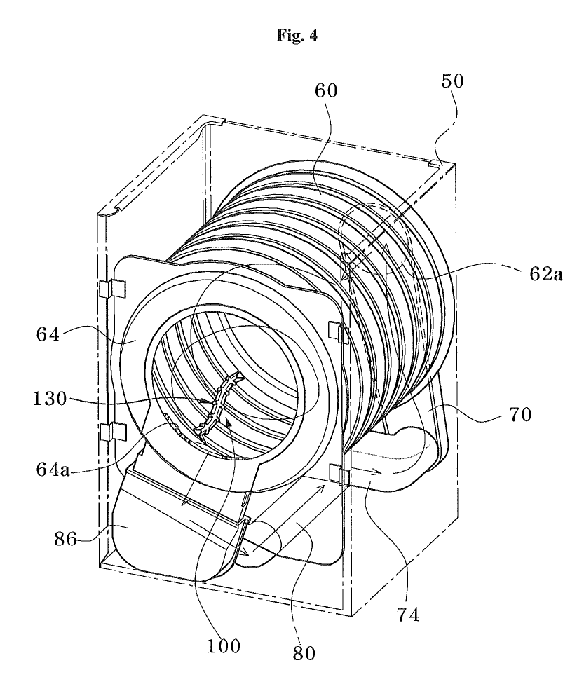

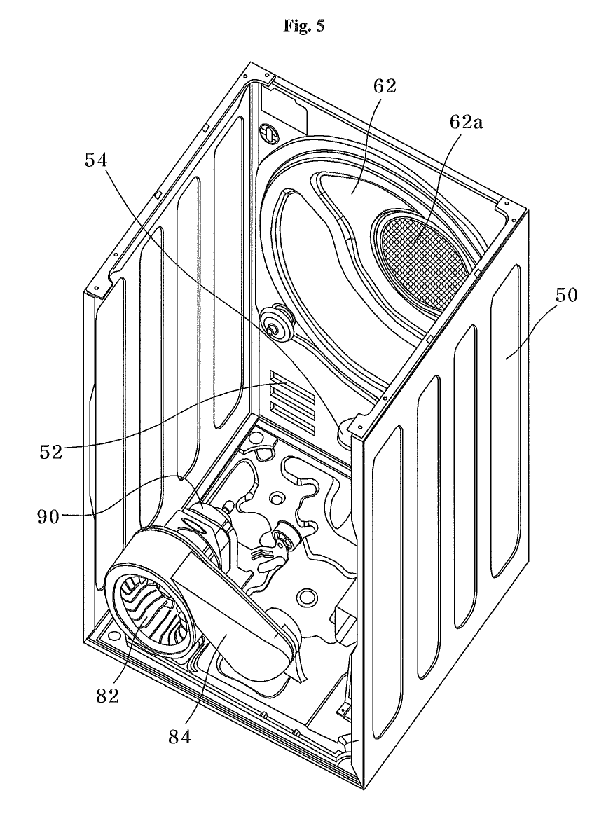

FIG. 3 is a rear perspective view of a dryer in accordance with one embodiment of the invention, FIG. 4 is a front perspective view of the dryer in accordance with the embodiment, and FIG. 5 is a rear perspective view of the dryer in accordance with the embodiment, which shows an intake port and an air vent of the dryer.

Referring to FIGS. 3 to 5, the dryer according to one embodiment includes a cabinet 50 having an intake port 52, an air vent 54, and an opening through which laundry is placed into or removed from the cabinet 50, a drum 60 rotatably disposed inside the cabinet 50 to receive the laundry, an intake fan 72 disposed inside the intake port 52, an intake duct 70 disposed between the drum 60 and the intake fan 72 to guide air introduced by the intake fan 72 to flow into the drum 60, a heater 74 disposed between the intake duct 70 and the intake fan 72, an exhaust fan 82 disposed between the drum 60 and the air vent 54, an exhaust duct 80 disposed between the exhaust fan 82 and the air vent 54, a drive motor 90 connected to rotational shafts of the intake fan 72 and the exhaust fan 82, and lifters 100 formed on an inner wall of the drum 60 to move laundry inside the drum 60.

When power is applied to the drive motor 90, the intake fan 72 and the exhaust fan 82 are rotated to cause circulation of air, which in turn is introduced into the cabinet through the intake port 52, heated by the heater 74 and supplied into the drum 60. Inside the drum 60, the heated air dries laundry while contacting the laundry.

Then, the air is exhausted from the air vent 54 of the cabinet 50 through the exhaust duct 80 by the exhaust fan 82.

Here, the intake port 52 and the air vent 54 are formed on a lower surface of the cabinet 50 and are separated a predetermined distance from each other.

The drum 60 has a cylindrical shape and is open at front and rear sides such that the opened front side of the drum 60 faces the opening of the cabinet 50. The rear side of the drum 60 is rotatably supported by a support panel 62 which has a through-hole 62a.

Further, a gasket 64 is disposed between the front side of the drum 60 and the opening of the cabinet 50 and is formed at a lower side thereof with a discharge port 64a.

The discharge port 64a is connected with an extension tube 86 extending toward the ventilation fan 82 and a housing 84 is disposed between the extension tube 86 and the exhaust duct 80 to accommodate the ventilation fan 82 such that the ventilation fan 82 can rotate inside the housing 84.

The intake duct 70 defines a passage extending from a rear lower portion of the cabinet 50 corresponding to the heater 74 to a rear upper portion of the cabinet 50 corresponding to the through-hole 62a, so that air introduced into the cabinet 50 by the intake fan 72 can be heated to a predetermined temperature or more while passing through the heater 74. Then, the heated air flows to the upper side of the cabinet 50 along the intake duct 70 and flows into the drum 60 through the through-hole 62a.

At this time, the drum 60 connected to the drive motor 90 via a belt 96 is rotated to increase a contact area between the heated air and laundry during a drying operation.

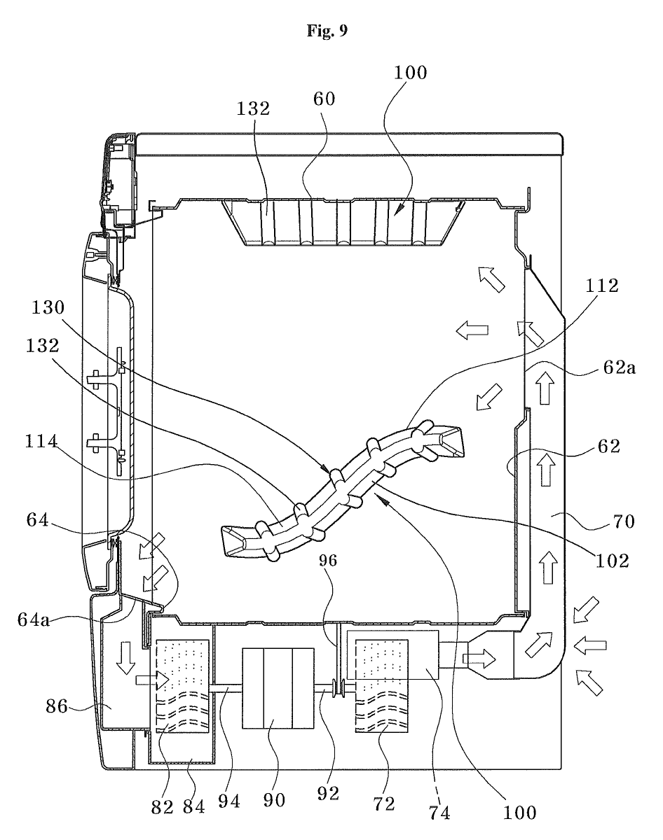

The drive motor 90 is a dual shaft motor, which is provided at one side thereof with a first rotational shaft 92 (see FIG. 9) connected to the intake fan 72 and is provided at the other side thereof with a second rotational shaft 94 (see FIG. 9) connected to the exhaust fan 82. Thus, when power is applied to the drive motor 90, the first and second shafts 92, 94 are simultaneously rotated.

Here, the first rotational shaft 92 is provided with the belt, which is fastened to the drum 60, so that the intake fan 72, the exhaust fan 82, and the drum 60 are simultaneously rotated when the power is applied to the drive motor 90.

Therefore, as the single motor is driven, air circulation into and from the drum 60 can occur along with the rotation of the drum 60.

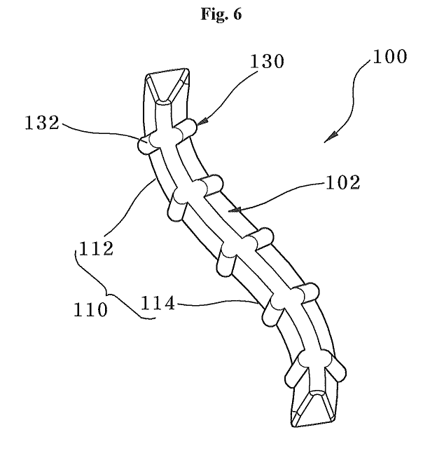

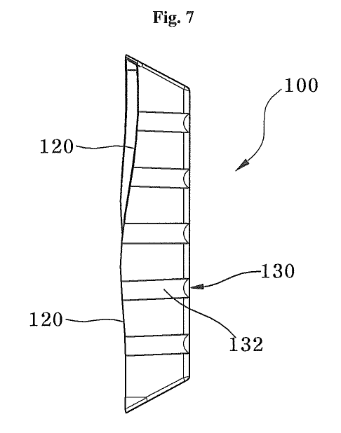

FIG. 6 is a plan view of a mixing type lifter in accordance with one embodiment of the invention, and FIG. 7 is a side view of the mixing type lifter in accordance with the embodiment.

Referring to FIGS. 6 and 7, the mixing type lifter 100 according to this embodiment includes a main body 102 provided to the drum 60 (see FIG. 3) to move laundry in the drum 60, a bent section 110 formed on the main body 102 to make three-dimensional movement of the laundry, and a separation maintaining section 130 formed on the main body 102 to form a space between the laundry and the main body 102.

When the drum 60 is rotated with laundry received therein, the main body 102 of the lifter 100 moves the laundry by lifting and dropping the laundry, which is lifted and slides along the bent section 110 to thereby perform three-dimensional movement. Here, since a space is defined between the laundry and the main body 102 of the lifter 100 by the separation maintaining section 130, the contact area between warm air and the laundry increases when the warm air passes through the space.

In this manner, as the contact amount between the warm air and the laundry increases, the dryer has improved drying efficiency, thereby reducing time and costs for drying operation.

Further, the main body 102 of the mixing type lifter 100 has a curved section 120 formed on one side thereof corresponding to an inner wall of the drum 60 so that the main body 102 can make close contact with the inner wall of the drum 60 corresponding to the one side of the lifter 100, thereby allowing the lifter 100 to be easily mounted on the drum.

Further, the bent section 110 includes a first bent section 112 formed by bending one end of the main body to have a predetermined radius of curvature and a second bent section 114 formed by bending the other end thereof in an opposite direction to the first bent section 112 to have a predetermined radius of curvature.

When the drum 60 is rotated with laundry received therein, the laundry is moved upward by the lifter 100 while sliding to the front side or the rear side of the drum 60 along a slanted plane formed between the first and second bent sections 112, 114, so that the laundry moves to the upper and lower sides or to the front and rear sides of the drum 60, thereby increasing the contact area with air passing through the drum 60.

The separation maintaining section 130 includes a plurality of protrusions 132 on a lateral side of the main body 102, so that the plurality of protrusions 132 form a space between the laundry and the main body 102 when the laundry is lifted by the main body 102. Thus, when warm air is supplied into the drum, the warm air passes through the space between the laundry and the main body 102, thereby increasing the contact area between the laundry and the warm air.

Further, when the laundry is dropped from the lifter 100, the main body 102 having the protrusions 132 cause the warm air to swirl while the laundry is rotated along the drum 60, so that it takes a long time for the warm air to pass through the interior of the drum 60, thereby increasing the contact time between the laundry and the warm air.

Next, an operation of the intake and exhaust devices of the dryer according to the embodiment constructed as above will be described.

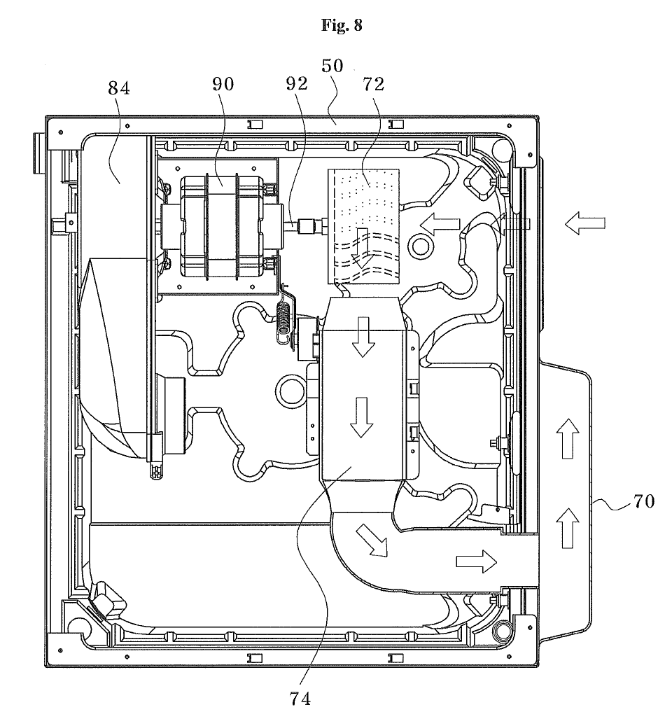

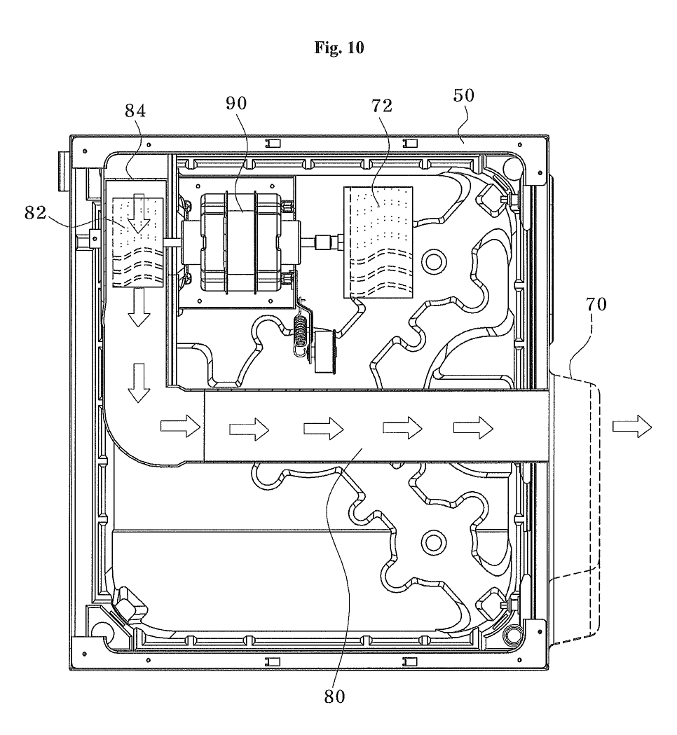

FIG. 8 is a plan view of an intake flow passage of the dryer in accordance with the embodiment, FIG. 9 is a side-sectional view of the intake flow passage of the dryer in accordance with the embodiment, and FIG. 10 is a plan view of a discharge flow passage of the dryer in accordance with the embodiment.

Referring to FIGS. 8 to 10, first, when power is applied to the drive motor 90, the drum 60 and the intake and exhaust fans 72, 82 connected to the first and second rotational shafts 92, 94 are rotated, so that air is introduced into the cabinet 50 through the intake port 52 by the intake fan 72 and supplied to the peripheral surface of the intake fan 72. Then, the air is heated to a predetermined temperature or more while passing through the heater 74 and flows to the upper side of the cabinet 50 along the intake duct 70, which vertically extends on the rear side of the cabinet 50.

The heated air introduced into the drum 60 through the through-hole 62a dries the laundry while swirling inside the drum 60. Then, the air is discharged from the drum 60 through the discharge port 64a, which is formed in the gasket 64 disposed between the inner wall of the cabinet 50 and the opening of the drum 60. The air discharged from the drum 60 passes through the connection tube 86, flows into the housing 84 of the exhaust fan 82, and is finally exhausted from the cabinet 50 through the air vent 54 (see FIG. 5) via the exhaust duct 80 of the housing 84.

Here, the laundry received in the drum 60 is moved by the main body 102 of the lifter 100. Since the laundry is three-dimensionally moved to the upper and lower sides of the drum 60 and to the front and rear sides of the drum 60 by the first and second bent sections 112, 114, the contact area between the laundry and the air passing through the drum 60 increases, thereby improving drying efficiency.

Further, when the laundry comes into contact with the main body 102, a space is formed between the main body 102 and the laundry by the plurality of protrusions 132, so that the warm air passes through the space between the main body 102 and the laundry inside the drum 60 to increase the contact area between the warm air and the laundry, thereby reducing the time for drying operation.

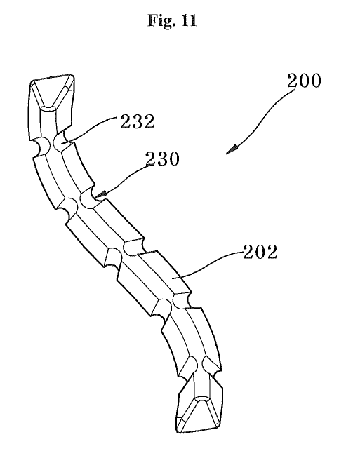

FIG. 11 is a plan view of a mixing type lifter in accordance with another embodiment of the invention.

Referring to FIG. 11, a mixing type lifter 200 according to this embodiment includes a separation maintaining section 230 that is formed on a main body 202 and includes grooves 232.

The grooves 232 are formed on a lateral outer wall of the main body 202 to form a space between the main body 202 and laundry when the laundry comes into close contact with the main body 202.

With this configuration, warm air passes through the space to increase the contact area between the laundry and the warm air, thereby improving drying efficiency of the dryer.

As such, the dryer according to the embodiments of the invention includes the mixing type lifter that increases the contact area between laundry and warm air.

As apparent from the description, in the dryer according to the embodiments, the lifter allows laundry to move three-dimensionally inside the drum while defining a space between the laundry and the lifter though which warm air passes, so that the contact area between the laundry and the air passing through the drum is increased to enhance drying efficiency, thereby reducing time and energy for the drying operation.

Although some embodiments have been provided to illustrate the invention in conjunction with the drawings, it will be apparent to those skilled in the art that the embodiments are given by way of illustration only, and that various modifications and equivalent embodiments can be made without departing from the spirit and scope of the invention. Further, the description of the dryer as provided herein is only one example of the invention and the lifter according to the invention can be applied to other products such as washing machines and the like. The scope of the invention should be defined only by the accompanying claims.

What is claimed is:

1. A dryer including a mixing type lifter,
wherein the lifter comprises:
a main body provided to a drum of the dryer to move laundry in the drum;
a bent section formed on the main body to make three-dimensional movement of the laundry; and
a separation maintaining section formed on the main body to form a space between the laundry and the main body.

2. The dryer according to claim 1, wherein the main body comprises a curved section on one side thereof corresponding to the drum.

3. The dryer according to claim 1, wherein the bent section comprises a first bent section formed at one end of the main body and a second bent section formed at the other end thereof and bent in an opposite direction to the first bent section.

4. The dryer according to claim 1, wherein the separation maintaining section comprises a protrusion formed on the main body.

5. The dryer according to claim 1, wherein the separation maintaining section comprises a groove formed on the main body.
